(19) United States
(12) Patent Application Publication
(10) Pub. No.: US 2026/0028517 A1
(43) Pub. Date: Jan. 29, 2026

(54) Phase Change Material Composites Including Carbon Nanomaterials

(71) Applicant: NEW JERSEY INSTITUTE OF TECHNOLOGY, Newark, NJ (US)

(72) Inventors: Eon Soo Lee, Tenafly, NJ (US); Niladri Talukder, Harrison, NJ (US)

(73) Assignee: NEW JERSEY INSTITUTE OF TECHNOLOGY, Newark, NJ (US)

(21) Appl. No.: 19/276,485

(22) Filed: Jul. 22, 2025

Related U.S. Application Data
(60) Provisional application No. 63/675,354, filed on Jul. 25, 2024.

(51) Int. Cl. C09K 5/06

(52) U.S. Cl. CPC C09K 5/06

(57) ABSTRACT

Phase change material (PCM) composites are disclosed. In one or more embodiments, the phase change material (PCM) composite includes one or more base phase change materials and a support material comprising one or more carbon nanomaterials, the support material being physically, chemically, or physicochemically integrated with the one or more base phase change materials.

### CROSS-REFERENCE TO RELATED APPLICATIONS

This application claims priority to U.S. Provisional Application No. 63/675,354, filed Jul. 25, 2024, the entire disclosure of which is hereby incorporated by reference herein.

### STATEMENT REGARDING FEDERALLY SPONSORED RESEARCH

This invention was made with government support under Agreement No. 1838369 awarded by the National Science Foundation. The government has certain rights in the invention.

### TECHNICAL FIELD

Embodiments of the present disclosure generally relate to phase change material composites including carbon nanomaterials. In particular, embodiments of the present disclosure relate to phase change material composites including modified carbon nanomaterials, including metal organic frameworks (MOFs), and/or including other 2D materials, and/or including any mixture of modified carbon nanomaterials, MOFs, and 2D materials.

### BACKGROUND

Phase change materials (PCMs) play a crucial role in temperature control and thermal management across diverse applications, spanning a wide range of operating temperatures. These materials undergo phase transitions, absorbing or releasing large amounts of latent heat, making them invaluable for storing and releasing thermal energy. The melting point of PCMs determines their operational temperature range; which is influenced by various factors, including composition, molecular structure, and purity.

Depending on their operational temperature range, PCMs are categorized into freezing/low temperature range (below 0° C.), domestic temperature range (approximately 0 to 30° C.), medium temperature range (around 30 to 100° C.), high-temperature range (above 100° C.), and extreme-temperature range (above 500° C.). In the design of PCMs, careful selection of materials is essential to ensure that their melting/freezing temperature aligns closely with the desired operational temperature.

Beyond the operational temperature, which depends on melting point, several other factors are important in the design of PCM materials. Key thermal properties include the latent heat of fusion, specific heat capacity, and thermal conductivity. High latent heat of fusion and specific heat capacity are desirable because these properties enable PCMs to store and release large amounts of heat. Thermal conductivity is also an important property to increase, in order to maximize the efficiency and utilization of a PCM's heat storage capacity. Despite this, most existing PCMs currently feature low thermal conductivity.

Thermal stability is another important property that influences the operational lifespan of PCMs. It is important for PCMs to maintain their structural integrity and phase change properties through multiple heating and cooling cycles to ensure reliable performance throughout their lifecycle. Most existing PCMs lack the ability to modify or improve thermal properties including the latent heat of fusion, specific heat capacity, thermal conductivity, and thermal stability, which leads to reduced system efficiency and lifespans.

Therefore, there remains an ongoing need for advanced phase change materials, including phase change material composites, having improved thermal conductivity without compromising other thermal properties including latent heat of fusion, specific heat capacity, and thermal stability.

### SUMMARY

One or more embodiments of the disclosure are directed to a phase change material (PCM) composite comprising one or more base phase change materials; and a support material comprising one or more modified carbon nanomaterials, the support material being physically, chemically, or physicochemically integrated with the one or more base phase change materials. In one or more embodiments, the one or more base phase change materials comprises an organic phase change material, an inorganic phase change material, or a eutectic phase change material. In one or more embodiments, the one or more modified carbon nanomaterials comprises a doped carbon nanomaterial, for example, a nitrogen doped (N-doped) carbon (NDC) nanomaterial.

Another embodiment pertains to a phase change material (PCM) comprising one or more carbon nanomaterials; and at least one of a two-dimensional (2D) material and a metal-organic framework (MOF) material integrated with the one or more carbon nanomaterials.

### BRIEF DESCRIPTION OF THE DRAWINGS

So that the manner in which the above recited features one or more embodiments of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically illustrates the synthesis of nitrogen doped graphene oxide (N-GO) according to one or more exemplary embodiments of the present disclosure;

FIG. 2 schematically illustrates the integration of graphene with a MOF, particularly a zeolitic imidazolate framework ZIF-8, according to one or more embodiments of the present disclosure;

FIG. 3 schematically illustrates a PCM composite material according to one or more embodiments of the present disclosure;

FIG. 4 graphically illustrates the DSC measurement of latent heat of fusion for pure paraffin wax (melting point 53-58° C., measured according to ASTM D 87); and

FIGS. 5-7 graphically illustrate the DSC measurements of latent heat of fusion for three N-G/paraffin wax composite samples, according to one or more embodiments of the present disclosure.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

According to one or more embodiments, the term “base PCM” refers to a pure PCM without any structural support materials or other additives. As used in this specification and the appended claims, the term “modified or improved thermal conductivity” when referencing a PCM composite refers to a thermal conductivity that is substantially the same as or greater than the thermal conductivity of the base PCM. In one or more embodiments, “substantially the same as” refers to a value that is within 2%, 1% or 0.5% of the value for the base PCM.

According to one or more embodiments, the term “improved latent heat of fusion” when referencing a PCM composite refers to a latent heat of fusion that is substantially the same as or greater than the latent heat of fusion of the base PCM. As described herein, one drawback with conventional PCM composites is that their latent heat of fusion is less than that of the base PCM. Thus, a PCM composite is understood herein as having an improved latent heat of fusion if the value does not decrease from that of the base PCM. As used in this specification and the appended claims, the term “modified or improved latent heat of fusion” when referencing a PCM composite refers to a latent heat of fusion that is substantially the same as or greater than the latent heat of fusion of the base PCM. According to one or more embodiments, the latent heat of fusion of the PCM composite is modified or improved when the value ranges from 100% the base PCM latent heat of fusion to about 150% the latent heat of fusion of the base PCM.

According to one or more embodiments, the term “improved specific heat capacity” when referencing a PCM composite refers to a specific heat capacity that is substantially the same as or greater than the specific heat capacity of the base PCM. As used in this specification and the appended claims, the term “modified or improved” specific heat capacity” when referencing a PCM composite refers to a specific heat capacity that is substantially the same as or greater than the specific heat capacity of the base PCM.

According to one or more embodiments, “improved thermal conductivity” refers to any thermal conductivity more than 100% of the pure PCM.

According to one or more embodiments, the term “modified thermal stability” when referencing a PCM composite refers to a thermal stability that is substantially the same as or greater than that of the base PCM, such that the PCM composite maintains its structural integrity and phase change properties over more heating and cooling cycles than the base PCM. The embodiments described herein generally provide improved PCM composites comprising one or more base PCMs and one or more support materials. In one or more embodiments, the one or more support materials are selected from carbon nanomaterials. In one or more embodiments, the support materials are selected from carbon nanomaterials and metal organic frameworks (MOFs), wherein one or more carbon nanomaterials are integrated with one or more MOFs, and/or including other 2D materials, and/or including any mixture of modified carbon nanomaterials, MOFs, and 2D materials.

The PCMs composites described herein according to one or more embodiments have applications across a range of technologies including, but not limited to, thermal management in heating, ventilation and air conditioning (HVAC) systems; electronic device manufacturing, such as enhancing thermal regulation in electronic devices to prevent overheating and improve performance; construction, such as providing better thermal insulation and energy efficiency in buildings; renewable energy, such as optimizing energy storage and transfer in renewable energy systems; delivery services, such as maintaining temperature control during the transportation of temperature-sensitive goods; medical devices, such as regulating temperature in sensitive medical equipment and storage of pharmaceuticals; automotive industries, such as enhancing thermal management in electric vehicle batteries and engines; aerospace, such as improving thermal control systems in spacecraft and satellites; wearable technology, such as integrating into clothing and accessories for personal temperature regulation; and the food industry, such as extending the shelf life and quality of perishable food items during storage and transport.

The integration of carbon nanomaterials as support materials for base PCMs has emerged as a potential strategy in PCM research, driven largely by the aim to enhance thermal conductivity of the base PCM. Carbon nanomaterials, including expanded graphite, carbon nanotubes (CNTs), graphene, and graphene oxide, have exceptionally high intrinsic thermal conductivity. The incorporation of carbon nanomaterials into PCMs demonstrates increased thermal conductivity to some degree, with the increase generally being incremental with the weight % of the support materials. However, such enhancement of thermal conductivity is generally accompanied by a reduction in the latent heat of fusion and specific heat capacity of the PCM. These opposing trends of thermal properties are generated from the distinct underlying mechanisms governing thermal conductivity, latent heat of fusion, and specific heat capacity. In a PCM composite formulated with a support material, thermal conductivity is influenced primarily by the structural and morphological uniformity of the support material. In such instances, the use of carbon nanomaterials as the support material may beneficially contribute to thermal conductivity due to their uniform structural arrangement. On the other hand, other thermal properties, including latent heat of fusion and specific heat capacity, are predominantly governed by intermolecular interactions within the materials. The introduction of carbon nanomaterials as a support material alters these intermolecular interactions with the base PCMs, leading to a reduction in both latent heat of fusion and specific heat capacity. Further, because carbon nanomaterials do not undergo a phase change, they do not possess a latent heat of fusion, which generally refers to the energy absorbed or released by a material during a phase change. As such, adding carbon nanomaterials to a base PCM dilutes the total PCM content in the resulting composite material which, in turn, reduces the latent heat of fusion of the composite. Generally, the higher the concentration of carbon nanomaterial in the PCM composite, the lower the latent heat of fusion.

In one or more embodiments of the present disclosure, improved PCM composites are developed using specific blends (by weight %) of one or more base PCMs combined with various support materials, as further described herein. The support materials can be selected from various compositions of carbon nanomaterials.

In one or more embodiments, the carbon nanomaterials are modified with one or more metal or non-metal elements. According to one or more embodiments, the carbon nanomaterials are modified or doped with one or more metal elements selected from transition metals and alkali metals, and/or one or more non-metal elements selected from nitrogen, boron, sulfur, and phosphorus. According to one or more embodiments, the carbon nanomaterials are nitrogen-doped (N-doped) carbon (NDC) nanomaterials. In one or more embodiments, at least a portion of the nitrogen in the NDC nanomaterials can be replaced with or can include one or more metal or non-metal elements.

In one or more embodiments, the carbon nanomaterials are integrated with one or more metal organic frameworks (MOFs). For example, one or more embodiments include doped carbon nanomaterials integrated with one or more MOFs, with one or more embodiments including nitrogen-doped carbon (NDC) nanomaterials integrated with one or more MOFs. In one or more embodiments the carbon nanomaterials are integrated with one or more 2D materials. In one or more embodiments, the carbon nanomaterials are integrated with one or more MOFs, and/or including other 2D materials, and/or including any mixture of modified carbon nanomaterials, MOFs, and 2D materials.

Unlike many current PCMs, which often feature low thermal conductivity and limited thermal stability, embodiments of the PCM composites described herein are designed to have modified thermal conductivity, while also improving or modifying one or more additional thermal properties. According to one or more embodiments, the PCM composites are designed to have improved thermal conductivity and an improved or modified latent heat of fusion, an improved or modified specific heat capacity, and/or an improved or modified thermal stability. Thus, the present PCM composites can advantageously store and release larger amounts of heat, with substantially improved efficiency, compared to currently existing PCMs, including currently existing PCM composites. In one or more embodiments, the PCM composites described herein are engineered to maintain their structural integrity and phase change properties over multiple heating and cooling cycles, ensuring a longer operational lifespan and more reliable performance compared to existing PCMs. While current PCM technologies may be limited in their applications due to specific material properties, the PCM composites one or more embodiments of the present disclosure are more versatile and can be modulated and independently tuned to meet the needs of various industries, including HVAC, electronic devices manufacturing, construction, renewable energy, and delivery services.

Many currently existing PCMs, when combined with carbon-based materials, suffer from a significant loss of latent heat of fusion and specific heat capacity in the effort to improve thermal conductivity. This trade-off greatly diminishes their ability to store and release heat effectively. The PCM composites described herein overcome these challenges by combining PCMs with one or more support materials that provide chemically tunable intermolecular interactions between the PCM molecules and the support materials. According to one or more embodiments, the support materials are selected from one or more carbon nanomaterials, one or more metal organic frameworks (MOFs), 2D materials, and combinations thereof. The one or more support materials are incorporated as design elements so as to allow for variations in the intermolecular interactions between the base PCM molecules and the support materials. In one or more embodiments, the intermolecular interactions are fine-tuned so that the PCM composites retain a high latent heat of fusion and specific heat capacity, while at the same time achieving an improved thermal conductivity. This balanced enhancement in thermal properties ensures that the PCM composites retain their heat storage and release capabilities, providing a more efficient and effective solution for thermal management and energy storage applications.

According to one or more embodiments, modification of the intermolecular interactions in the PCM composites is accomplished by adjusting the weight ratios between the PCMs and support materials (i.e., carbon nanomaterials and/or MOFs). According to one or more embodiments, modification of the intermolecular interactions in the PCM composites is accomplished by using external means to promote the interaction between PCMs and support materials. According to one or more embodiments, modification of the intermolecular interactions in the PCM composites is accomplished by modifying the elements and chemical functional groups of both the PCMs and the support materials. According to one or more embodiments, modification of the intermolecular interactions in the PCM composites can be accomplished by any combination of the above techniques.

In one or more embodiments, the PCM composites comprise one or more base PCMs and one or more carbon nanomaterials, metal organic frameworks (MOFs), 2D materials, or a blend of these. The composites can leverage chemically tunable intermolecular interactions between PCM molecules and the support materials, such as carbon nanomaterials and metal organic frameworks (MOFs), and 2D materials. The intermolecular interactions govern the retention of high latent heat of fusion and specific heat capacity while, at the same time, provide enhanced thermal conductivity. In one or more embodiments, the present PCM composites can be tailored to meet specific technology requirements, ensuring versatility and consistent performance. The PCM composites of one or more embodiments also demonstrate very high structural integrity and thermal stability over prolonged operational periods. The PCM composites provide a solution for efficient thermal management and energy storage across various industries, including but not limited to HVAC, electronics manufacturing, construction, renewable energy, and delivery services.

This dual influence of carbon nanomaterials as a support material for base PCMs underscores the importance of balancing thermal conductivity enhancement and minimizing the reduction of phase change properties including latent heat of fusion and specific heat capacity of the PCM composites. Thus, in one or more embodiments, the PCM composites incorporate modified carbon nanomaterials that are designed to achieve the desired balance between enhanced thermal conductivity and preserved phase change characteristics.

In one or more embodiments, the PCM composites described herein comprise one or more base PCMs. The one or more base PCMs may include one or more of inorganic salts, salt hydrates, organic polymers, eutectic compositions of inorganic and/or organic components, or binary eutectic alloys. In one or more embodiments, the base PCM may comprise a wax, such as a paraffin wax. In one or more embodiments, the paraffin wax comprises paraffin wax 48.

Base PCMs can also be classified based on composition into organic, inorganic, and eutectic types. Organic PCMs include substances such as paraffin waxes and fatty acids, while inorganic PCMs encompass materials like salt hydrates and certain metal alloys. Eutectic PCMs are mixtures of different thermally compatible and mutually soluble substances, engineered to achieve specific melting points within desired temperature ranges.

Carbon nanomaterials suitable for use in the present PCM composites, include, but are not limited to, expanded graphite, graphene, reduced graphene oxide, nitrogen-doped graphene, carbon nanotubes (CNTs), fullerene, and Buckminsterfullerene, which all have very high intrinsic thermal conductivity. This exceptional property arises from the strong carbon-carbon sp² bonds within the material and an abundance of free electrons in their structure, specifically free electrons formed in the pi-electron network. These structural features facilitate efficient heat conduction within the materials through both phonon and electron transport modes.

In one or more embodiments, one or more physical, chemical, or physicochemical compositions of carbon nanomaterials are physically, chemically, or physicochemically integrated with one or more base PCMs.

In one or more embodiments, the one or more carbon nanomaterials are modified or doped carbon nanomaterials. In particular, according to one or more embodiments, modification of the intermolecular interactions in the PCM composites is accomplished by modifying the elements and chemical functional groups of the PCMs and the carbon nanomaterials. This can be achieved by modifying or doping the carbon nanomaterials. According to one or more embodiments, the one or more carbon nanomaterials are modified or doped with one or more metal or non-metal elements which include, but are not limited to, transition metals, alkali metals, nitrogen, boron, sulfur, and phosphorus. According to one or more embodiments, the carbon nanomaterials comprise a nitrogen-doped carbon (NDC) nanomaterial. It was found that nitrogen-doped carbon (NDC) nanomaterials interact with base PCM molecules, including through the nitrogen atom of the NDC nanomaterial. When NDC nanomaterials were integrated as support materials for base PCMs to form the PCM composites, a significant enhancement in the thermal conductivity of the composite is obtained. Likewise, in the case carbon nanomaterials doped with one or more transition metals, alkali metals, boron, sulfur, and/or phosphorous, these doped carbon nanomaterials interact with base PCM molecules, including through the dopant atom, providing significant enhancement in the thermal conductivity of PCM composites.

In one or more embodiments, the PCM composite comprises a base PCM, an NDC nanomaterial support, and one or more 2-dimensional (2D) materials integrated with the NDC nanomaterial support. Non-limiting examples of 2D materials that can be integrated into the NDC nanomaterial supports include two-dimensional silica, MXenes, boron nitride, and titanate nanosheets.

It has been found that the presence of nitrogen atoms (or in the case of transition metals, alkali metals, boron, sulfur, and phosphorus modified or doped carbon nanomaterials, then the presence of atoms of these transition metals, alkali metals, boron, sulfur, or phosphorus) in the carbon nanomaterial improves the intermolecular interactions between the support materials and the base PCMs molecules. According to embodiments, the presence of these atoms and their intermolecular interactions with the base PCM provides PCM composites that substantially retain the base PCM latent heat of fusion and specific heat capacity, while at the same time increasing the thermal conductivity. In one or more embodiments, this dual improvement allows the PCM composites to be tailored to specific applications by independent adjustment of their thermal properties. In one or more embodiments, the intermolecular interactions provided by the modified or doped carbon nanomaterials enable the PCM composites to maintain their structural integrity and thermal stability over extended periods of operation, thus providing for reliable performance and longevity. Modification of the intermolecular interactions in the PCM composites of one or more embodiments was conducted in various ways, including adjustment of weight ratios between PCMs and support materials, using external means to promote the interaction between PCMs and support materials, and/or modifying the elements and chemical functional groups of the PCMs and/or support materials. Finally, through structural-functional modification, the PCMs composites with improved or modified thermal properties and stabilities were produced, as described in the present disclosure, including the examples.

In one or more embodiments, the PCM composites include a nitrogen doped carbon (NDC) nanomaterial, and at least a portion of the nitrogen in the NDC nanomaterials is replaced with or can further include one or more metal elements including transition metals and alkali metals. In one or more embodiments, at least a portion of the nitrogen in the NDC nanomaterials is replaced with, or can further include one or more non-metal elements including boron, sulfur, and phosphorus.

One or more embodiments of the present disclosure are directed to PCM composites comprising one or more base PCMs and one or more carbon nanomaterials, wherein the carbon nanomaterial is further integrated with one or more MOFs. In one or more embodiments, the one or more carbon nanomaterials integrated with the one or more MOFs provides a support material for the one or more base PCMs. In one or more embodiments, the one or more carbon nanomaterials comprises a nitrogen-doped carbon (NDC) nanomaterial. In one or more embodiments, the one or more MOFs are selected from the group consisting of zeolitic imidazolate frameworks (ZIFs), Materials Institute Lavoisier (MIL) MOFs, Porous Coordination Networks (PCNs), Porous Coordination Polymers (PCPs), University of Oslo (UiO) MOFs, and combinations thereof. In one or more embodiments, the one or more MOFs comprises zeolitic imidazolate framework 8 (ZIF-8). UiO MOFs include, but are not limited to UiO 66, 67 and 68, which are characterized by their high thermal and chemical stability, tunable porosity, and potential for various applications, have been extensively studied and utilized. These UiO MOFs are Zr-based MOFs, having a unique structure topology and chemical and thermal stability. In one or more embodiments, the PCM composite may comprise one or more base PCMs and one or more MOFs, where the one or more MOFs may or may not be integrated with one or more carbon nanomaterial. Materials of Institute Lavoisier (MIL) metal-organic frameworks (MOFs) are a prominent subclass of MOFs, known for their crystalline, porous structures formed by metal ions or clusters coordinated with organic ligands. Developed primarily at the Institut Lavoisier de Versailles, these materials are distinguished by their large specific surface areas (often 500-7000 m²/g), tunable pore sizes (micro- to mesoporous), high thermal stability (250-500° C.), and flexible structures. MILs consist of metal nodes (e.g., Fe, Al, Cr, Zr) connected by organic linkers, typically carboxylate-based (e.g., terephthalic acid, trimesic acid). The pore size and structure can be adjusted through synthesis conditions or external stimuli, offering versatility. Examples of MILs include MIL-53, MIL-88, MIL-100, MIL-101, MIL-125, MIL-127, and MIL-96, each with unique properties. In one or more embodiments, the MOFs are modified with one or more metal or non-metal elements. According to one or more embodiments, the MOFs nanomaterials are modified or doped with one or more metal elements selected from transition metals and alkali metals, and/or one or more non-metal elements selected from nitrogen, boron, sulfur, and phosphorus.

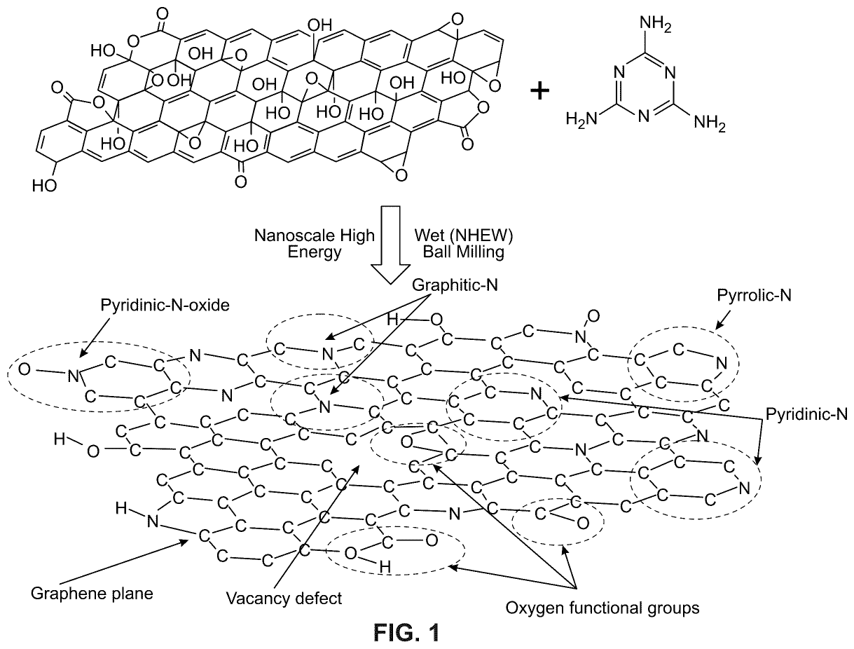

FIG. 1 schematically illustrates a nitrogen doped carbon nanomaterial according to one or more embodiments. In particular, according to one or more embodiments, the carbon nanomaterial can be an N-doped graphene oxide (N-GO). In one or more embodiments, the N-doped graphene oxide can be fabricated by reacting graphene oxide with melamine as a nitrogen source, as further described in the Examples. According to one or more embodiments, the carbon nanomaterials can be modified or doped with one or more metal elements (e.g., transition metals, alkali metals) and/or non-metal elements (e.g., boron, sulfur, phosphorus).

In one or more embodiments, at least a portion of the nitrogen in the NDC nanomaterial, for example the N-GO nanomaterial illustrated in FIG. 1, is replaced with, or includes one or more metal elements (e.g., transition metals or alkali metals). In one or more embodiments, at least a portion of the nitrogen in the NDC nanomaterial is replaced with one or more non-metal elements (e.g., boron, sulfur, and phosphorus).

Structural integrity and thermal stability of Phase Change Materials (PCMs) denotes their resistance to physical and chemical alterations during repeated thermal cycles. Various intrinsic properties of PCMs, including chemical composition, molecular weight and size, chemical bond strength, and crystallinity, influence their thermal stability. However, enhancing the thermal stability of PCMs is feasible through the incorporation of metal or semi-metal-based nanoparticles, provided effective interaction occurs between the PCM molecules and nanoparticles, resulting in improved structural integrity and heightened resistance to structural changes during thermal cycling. This phenomenon mirrors observations made in the thermal stability of diverse polymer-based materials. To bolster thermal stability, in one or more embodiments, MOFs are further incorporated into the support material of the present PCM composites. MOFs are metal-based nano-sized framework structures that enhance structural stability, complemented by organic ligands containing diverse chemical moieties. These ligands facilitate enhanced interaction between MOF particles and PCM molecules, thereby improving thermal stability.

With well-defined chemical and crystal structures, the MOFs of the present embodiments help maintain the alignments of PCM molecules to increase structural stability, and they can further improve the thermal stability and durability of the PCMs.

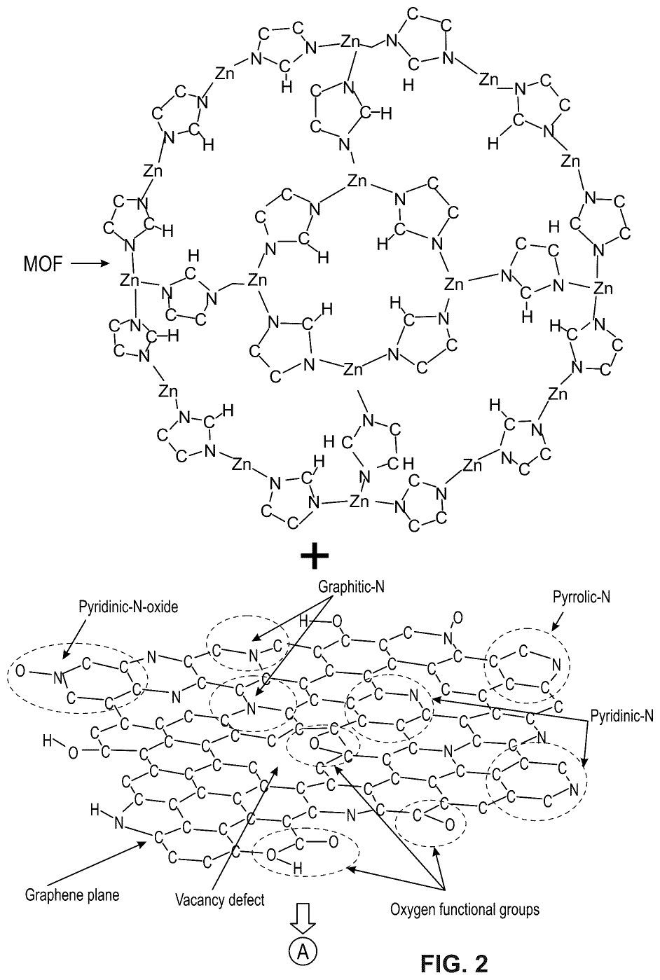

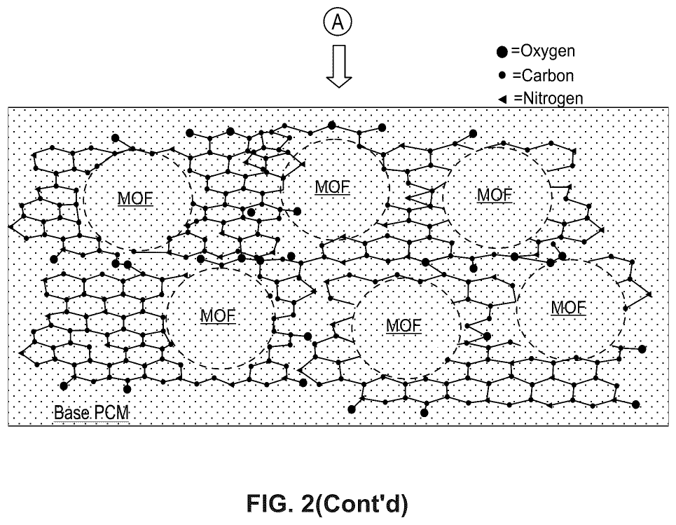

FIG. 2 schematically illustrates a metal organic framework (MOF) integrated with a modified carbon nanomaterial according to one or more embodiments. In particular, zeolitic imidazolate framework (ZIF), particularly ZIF-8, is schematically illustrated integrated with nitrogen doped graphene oxide (N-GO). This structural support (or similar structural supports which integrate one or more MOFs with one or more doped carbon nanomaterials according to the present embodiments) can then be combined with a base PCM to provide an improved PCM composite according to one or more embodiments of the present disclosure. The bottom portion of FIG. 2 schematically illustrates a PCM composite integrated with carbon nanomaterials including NDCs and MOFs. It is noted that in the bottom portion of FIG. 2, the MOFs are shown only schematically as dotted line circles, and not all of the bonding sites are illustrated.

In one or more embodiments, one or more MOFs are physically, chemically, or physicochemically integrated with the one or more carbon nanomaterials to form the support material of the PCM composite. Many phase change materials decompose into smaller molecules at elevated temperatures, which can result in an undesirable weight loss of the phase change material. Without being bound by theory, incorporating one or more MOFs into the present PCM composites further provides a PCM composite having improved structural stability and intermolecular interactions that make it capable of increased weight retention as the PCM composite is heated to elevated temperatures.

The combination of carbon nanomaterials and MOFs to form support materials for PCMs, according to one or more embodiments of the present disclosure, provides PCM composites having one or more advantages. For example, one or more embodiments of the present PCM composites provide a significantly higher thermal conductivity relative to the base PCM. The present PCM composites and methods of fabrication enable the improvement or modification of additional thermal properties such as latent heat of fusion and specific heat capacity. This is in contrast with conventional PCM composites which, while they are capable of improving thermal conductivity, provide undesirable decreases in both latent heat of fusion and specific heat capacity. The present PCM composites further provide improved structural and chemical stability relative to the base PCM. The present PCM composites also provide improved thermal stability relative to the base PCM, thus providing increased overall durability of the PCM composite.

Incorporating a combination of carbon nanomaterials, including NDC nanomaterials, and MOFs into a base PCM to form a PCM composite according to one or more embodiments can be used to improve or modify the thermal properties of the PCM composite, including through fine-tuning intermolecular interactions as discussed herein. The structural forms of the present support materials also improve the PCM composites' physical integrity and thermal stability. The present approach can beneficially be used to create PCM composites with increased or modified thermal storage capacity, enhanced thermal conductivity, and improved thermal stability.

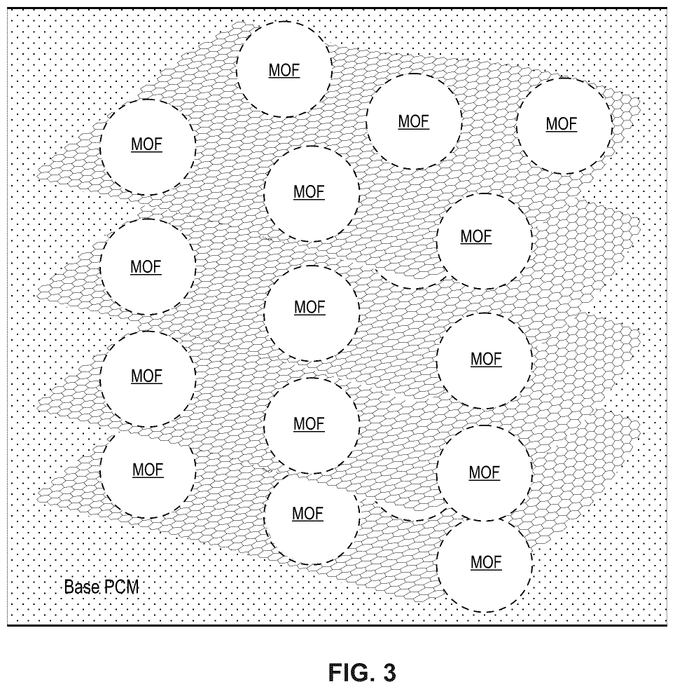

A schematic representation of a PCM composite material according to an embodiment, having a carbon nanomaterial and MOF support, is shown in FIG. 3. As in FIG. 3, the MOFs are schematically represented as dotted line circles and all of the bonding sites are not illustrated. By adjusting the weight ratios of the carbon nanomaterials and MOFs, the thermal properties of the PCM can be significantly increased or modified. Simultaneously, the thermal stability of the present PCM composites is significantly improved, thus enhancing the operational lifespan of the PCM over many operation cycles.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

### EXAMPLES

### Example 1: Synthesis of a Nitrogen-Doped Graphene Oxide (N-GO) Support for a Paraffin Wax Base PCM

In this study, a formulation of a PCM composite comprising an N-doped carbon (NDC) nanomaterial support was formulated and demonstrated to provide improvement and balance of important thermal properties. A commercially available Paraffin Wax (Paraffin wax 48) was used as the base PCM, and nitrogen-doped graphene oxide (N-GO) was used as the carbon nanomaterial.

The N-GO nanomaterial was synthesized by a Nanoscale High Energy Wet (NHEW) ball milling method. The synthesis was conducted by grinding GO and melamine powders under a deionized water environment in a planetary ball milling machine (PM100, Retsch Inc.). The kinetic energy generated by the rotation of the grinding balls inside the grinding jar activated reactants so that the synthesis reactions could proceed during the milling process. The solid precursor particles were reduced into small particles and activated by collisions from the grinding media. Therefore, nitrogen atoms from melamine were doped on activated GO particles, producing N-GO nanoparticles at a temperature much lower than the temperature required using conventional chemical methods. Throughout the whole milling process, the synthesis environment was maintained below 70° C.; with the highest temperature recorded during the reaching 67° C. Therefore, problems such as sintering, overheating, or coking were negligible during the synthesis process. It is well known that the grinding speed and grinding time are primary influencing factors during the ball milling process. The synthesis process can be controlled by adjusting grinding speed and grinding time with the same grinding jar and grinding media conditions. FIG. 1 schematically illustrates the N-GO nanomaterial synthesis by the NHEW ball milling process. The process is as follows: First, GO particles as a carbon source and melamine particles as a nitrogen source were mixed in deionized water (8 mL) with a specific weight ratio (5 mg GO with 30 mg melamine). The suspension solution was heated to 60° C. to dissolve melamine in the solution. After cooling down the solution to room temperature, it was dispersed by ultrasonication to produce a well-dispersed precursor solution. The precursor solution was then moved to a stainless-steel grinding jar (12 mL) with grinding balls (15 g, 1.4 to 1.7-mm diameter balls) made of yttria-stabilized zirconia (YSZ).

The nitrogen doping ratio in the graphene oxide can be controlled by adjusting the synthesis parameters like grinding speed and time. In this example, the precursor materials were ground at 500 rpm speed for 1 hour of grinding time in order to prepare N-GO nanomaterial samples. Higher doping levels are generally achieved with faster grinding speed and time. The ground solution was heated to 60° C. and then centrifuged three times (4000 rpm for 8 minutes) to remove unreacted melamine particles and other soluble components. The extracted solid powders were then dried in a vacuum oven to obtain the final N-GO nanomaterial.

### Example 2: Integration of N-GO Nanomaterial with the Paraffin Wax Base PCM

The N-GO nanomaterial was synthesized according to the procedure of Example 1. At this stage, nitrogen-doped graphene oxide (N-GO) was incorporated into the base phase change material (PCM), paraffin wax. Ensuring the homogeneity of the components in the mixture was crucial, as was achieving intermolecular interactions between the PCM molecules and N-GO particles. The paraffin wax, with a melting point of approximately 55° C., was heated to 60° C. to liquefy it. In this molten state, 2 wt. % of N-GO nanoparticles based on the total weight of the PCM composite was added. Maintaining the temperature at 60° C., the mixture was sonicated for 10 minutes using a sonication power of 200 W. This sonication process produced a homogeneous mixture and, with the energy supplied through sonication, facilitated molecular-level interactions between the N-GO and paraffin wax. Although N-GO is denser than the PCM molecules, the mixture's homogeneity was sustained due to the nanoscale size of the N-GO particles and the highly viscous nature of the paraffin wax. After sonication, the mixture was rapidly cooled to form a homogeneous solid-solid composite. A PCM-NDC (nitrogen-doped carbon) composite was thus produced.

### Example 3: Latent Heat of Fusion Measurements

Paraffin wax (melting point 53-58° C., measured according to ASTM D 87) was selected as the base PCM in this example. This paraffin wax is a widely used commercial PCM, known for its well-established properties such as stable phase transitions, high latent heat of fusion, and broad availability at a relatively low cost. Its ability to efficiently store and release thermal energy makes it suitable for a wide range of applications, including thermal energy storage and temperature regulation across various industries. Therefore, a direct comparison of the latent heat of fusion between pure paraffin wax and paraffin wax integrated with a carbon nanomaterial, N-doped graphene (N-G), according to the present disclosure can be made.

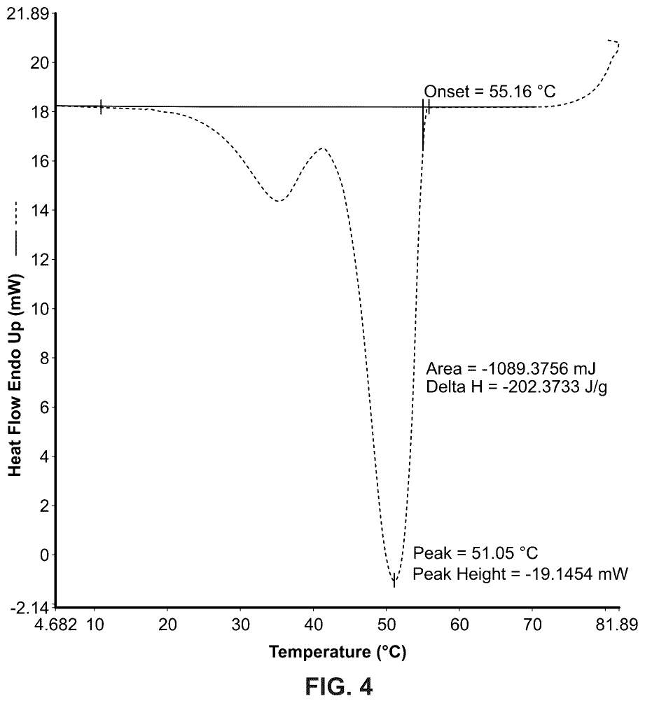

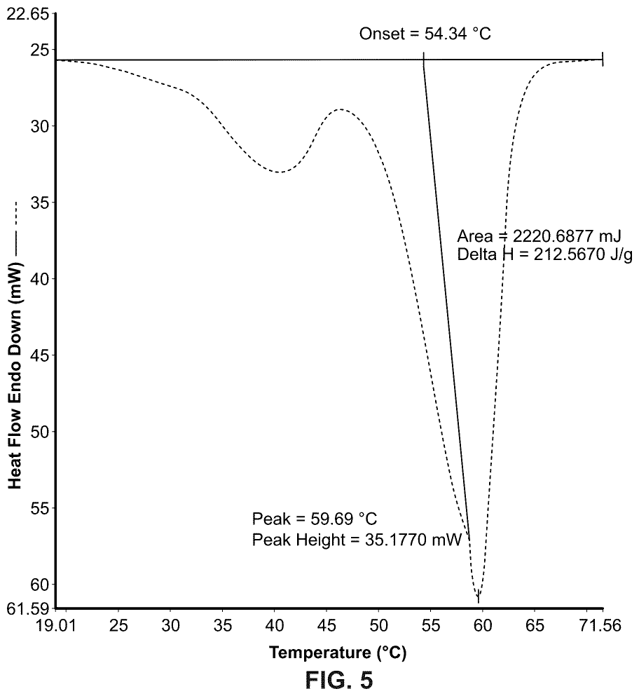

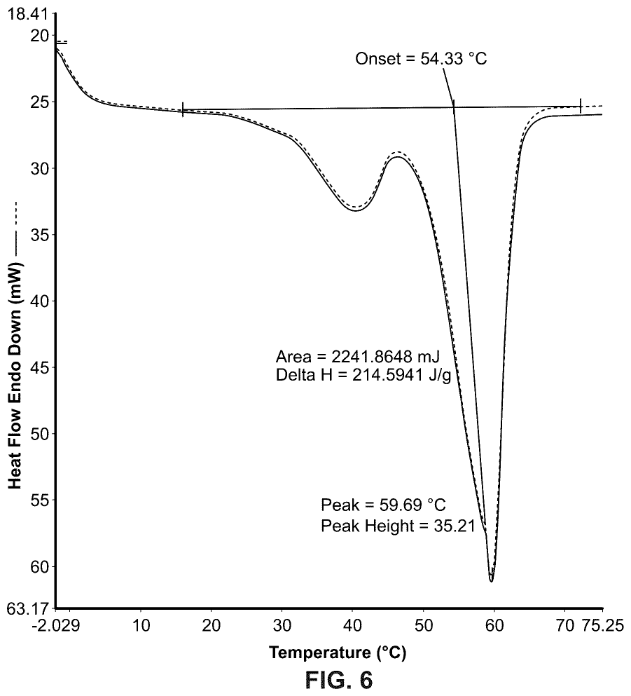

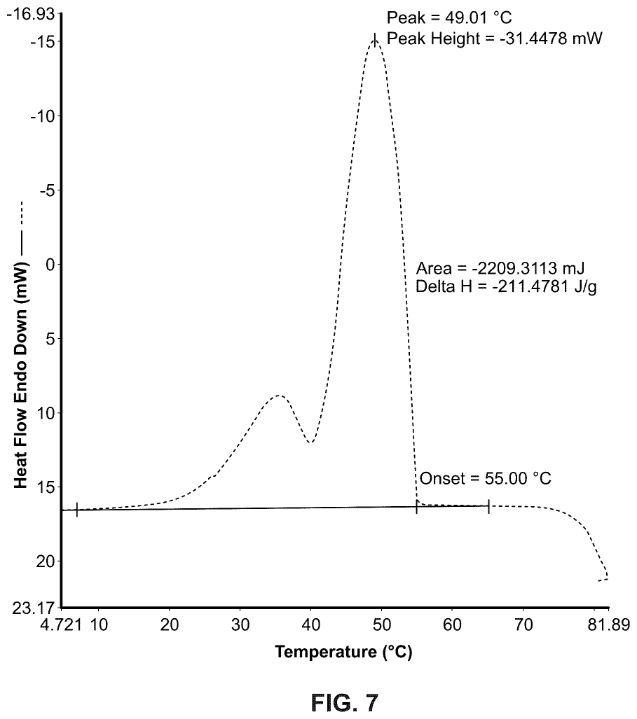

A 2 wt. % concentration of N-doped graphene (N-G) as the modified carbon nanomaterial was incorporated into the base PCM (paraffin wax). Three trials were performed using three separately prepared samples. The latent heats of fusion of the base PCM and each of the PCM composite samples were measured using Differential Scanning calorimetry (DSC). FIG. 4 graphically illustrates the DSC measurement of latent heat of fusion for pure paraffin wax. FIGS. 5-7 graphically illustrate the DSC measurements of latent heat of fusion for the three N-G/paraffin wax composite samples, respectively. The results are further presented in Table 1.

As clearly demonstrated by the data, incorporating a doped carbon nanomaterial, particularly 2 wt. % N-G into paraffin wax in accordance with one or more embodiments of the present disclosure provides a PCM composite that increases the latent heat of fusion of the composite PCM (by about 5%) as compared to that of the base PCM (pure paraffin wax) due to the enhanced molecular-level interactions provided between the doped carbon nanomaterials and the base PCM.

TABLE 1
Latent Heat of Fusion of Base PCM and PCM Composites
Measured by Differential Scanning Calorimetry (DSC)

| Materials | Latent Heat of Fusion (J/g) |
|---|---|
| Paraffin wax (melting point 53-58° C., | 202.37 |
| ASTM D 87) | |
| Paraffin wax + 2 wt. % N-G (1st trial) | 212.56 |
| Paraffin wax + 2 wt. % N-G (2nd trial) | 214.59 |
| Paraffin wax + 2 wt. % N-G (3rd trial) | 211.47 |

In contrast, J. Lee et al. (J. Lee, H. Han, D. Noh, J. Lee, D. D. Lim, J. Park, G. X. Gu, and W. Choi, Multiscale Porous Architecture Consisting of Graphene Aerogels and Metastructures Enabling Robust Thermal and Mechanical Functionalities of Phase Change Materials. Adv. Funct. Mater. 2024, 34, 2405625) describes a process in which graphene aerogels (GAs) and 3D-printed mechanical metamaterials (3D-MPGA) were combined with paraffin wax (melting point 53-58° C., ASTM D 87) to form PCM composites. According to J. Lee et al., a reduction in latent heat of fusion (about a 5-9% reduction) was measured and recorded, as set forth in Table 2 below.

TABLE 2
Latent Heat of Fusion of Base PCM and PCM Composites
Measured by Differential Scanning Calorimetry
(DSC), measured by J. Lee et al.

| Materials | Latent Heat of Fusion (J/g) |
|---|---|
| Paraffin wax (melting point 53-58° C., | 183.34 |
| ASTM D 87) | |
| Paraffin wax + GAs | 173.67 |
| Paraffin wax + 3D-MPGA | 167.35 |

W. Li et al. (W. Li, Y. Dong, X. Zhang, and X. Liu, Preparation and Performance Analysis of Graphite Additive/Paraffin Composite Phase Change Materials. Processes 2019, 7(7), 447) investigated the incorporation of expanded graphite (EG), graphene oxide (GO), and graphene (GR) into paraffin wax at different weight percentages. As shown in Table 3 below, which sets forth data measured by W. Li et al., their inclusion of just 2 wt. % of EG, GO, or GR led to a notable decrease (about 30-33%) in the latent heat of fusion of the PCM composite as compared to the base PCM (pure paraffin wax) composite.

TABLE 3
Latent Heat of Fusion of Base PCM and PCM Composites
Measured by Differential Scanning Calorimetry
(DSC), measured by W, Li et al.

| CPCM | Melting Point (° C.) | Latent Heat (J/g) |
|---|---|---|
| Pure paraffin | 52 | 146.97 |
| +0.5% EG | 51 | 137.56 |
| +1.0% EG | 51 | 125.47 |
| +1.5% EG | 52 | 113.98 |
| +2.0% EG | 53 | 101.84 |
| +0.5% GO | 51 | 129.41 |
| +1.0% GO | 51 | 119.57 |
| +1.5% GO | 52 | 108.69 |
| +2.0% GO | 55 | 100.76 |
| +0.5% GR | 52 | 131.60 |
| +1.0% GR | 52 | 118.51 |
| +1.5% GR | 55 | 106.12 |
| +2.0% GR | 56 | 98.33 |

The Examples demonstrate that previous attempts to add various materials to paraffin wax consistently reduces the latent heat of fusion of the resulting PCM composite material. In contrast, the PCM composites according to one or more embodiments of the present disclosure, which incorporate modified carbon nanomaterials provide a latent heat of fusion that was not only preserved, but increased compared to a base PCM (e.g., a paraffin+2 wt. % N-G composite demonstrated a latent heat of fusion that was about 105% the latent heat of fusion of the base PCM), due to the molecular-level interactions introduced during the integration process.

What is claimed is:

1. A phase change material (PCM) composite comprising:
one or more base phase change materials; and
a support material comprising one or more modified carbon nanomaterials,
the support material being physically, chemically, or physicochemically integrated with the one or more base phase change materials.

2. The phase change material (PCM) composite of claim 1, wherein the one or more base phase change materials comprises an organic phase change material, an inorganic phase change material, or a eutectic phase change material.

3. The phase change material (PCM) composite of claim 1, wherein the one or more base phase change materials is selected from the group consisting of inorganic salts, salt hydrates, organic polymers, eutectic compositions of inorganic and/or organic components, binary eutectic alloys, metal alloys, paraffin waxes, and combinations thereof.

4. The phase change material (PCM) composite of claim 1, wherein the one or more modified carbon nanomaterials comprises a doped carbon nanomaterial.

5. The phase change material (PCM) composite of claim 4, wherein the doped carbon nanomaterial comprises one or more metal elements.

6. The phase change material (PCM) composite of claim 4, wherein the doped carbon nanomaterial comprises one or more non-metal elements selected from the group consisting of nitrogen, boron, sulfur, phosphorus, and combinations thereof.

7. The phase change material (PCM) composite of claim 4, wherein the doped carbon nanomaterial is a nitrogen doped (N-doped) carbon nanomaterial.

8. The phase change material (PCM) composite of claim 1, wherein the one or more modified carbon nanomaterials comprises a carbon nanomaterial selected from the group consisting of expanded graphite, graphene, reduced graphene oxide, nitrogen-doped graphene, nitrogen-doped graphene oxide, carbon nanotubes, fullerene, Buckminsterfullerene, and combinations thereof.

9. The phase change material (PCM) composite of claim 8, further comprising one or more metal organic frameworks (MOFs) integrated with the one or more modified carbon nanomaterials.

10. The phase change material (PCM) composite of claim 9, wherein the one or more metal organic frameworks (MOFs) is physically, chemically, or physicochemically integrated with the one or more modified carbon nanomaterials.

11. The phase change material (PCM) composite of claim 9, wherein the one or more metal organic frameworks (MOFs) is selected from the group consisting of zeolitic imidazolate frameworks (ZIFs), Materials Institute Lavoisier (MIL) MOFs, porous coordination networks (PCNs), porous coordination polymers (PCPs), University of Oslo (UiO) MOFs, and combinations thereof.

12. The phase change material (PCM) composite of claim 11, wherein the zeolitic imidazolate framework comprises ZIF-8.

13. The phase change material (PCM) composite of claim 1, further comprising a two-dimensional (2D) material integrated with the modified carbon nanomaterial.

14. The phase change material (PCM) composite of claim 13, wherein the two-dimensional (2D) material is selected from the group consisting of boron nitride nanosheets, two-dimensional silica, MXenes, titanate nanosheets, and combinations thereof.

15. The phase change material (PCM) composite of claim 1, wherein a thermal conductivity of the PCM composite is higher than a thermal conductivity of the one or more base phase change materials without the one or more modified carbon nanomaterials.

16. The phase change material (PCM) composite of claim 15, wherein a latent heat of fusion and a specific heat capacity of the PCM composite are substantially the same as or higher than a latent heat of fusion and a specific heat capacity of the one or more base phase change materials without the one or more modified carbon nanomaterials.

17. A phase change material (PCM) comprising:
one or more carbon nanomaterials; and
at least one of a two-dimensional (2D) material and one or metal-organic frameworks (MOFs) material integrated with the one or more carbon nanomaterials.

18. The phase change material (PCM) of claim 17, wherein the one or more carbon nanomaterials is a doped carbon nanomaterial.

19. The phase change material (PCM) of claim 18, wherein the doped carbon nanomaterial comprises one or more metal elements.

20. The phase change material (PCM) of claim 18, wherein the doped carbon nanomaterials comprises one or more non-metal elements selected from the group consisting of nitrogen, boron, sulfur, phosphorus, and combinations thereof.

21. The phase change material (PCM) of claim 20, wherein the doped carbon nanomaterial is a nitrogen doped (N-doped) carbon nanomaterial.

22. The phase change material (PCM) of claim 17, wherein the one or more metal organic frameworks (MOFs) is selected from the group consisting of zeolitic imidazolate frameworks (ZIFs), Materials Institute Lavoisier (MIL) MOFs, porous coordination networks (PCNs), porous coordination polymers (PCPs), University of Oslo (UiO) MOFs, and combinations thereof.

23. The phase change material (PCM) of claim 22, wherein the zeolitic imidazolate framework comprises ZIF-8.

24. The phase change material (PCM) claim 17, wherein the two-dimensional (2D) material is selected from the group consisting of boron nitride nanosheets, two-dimensional silica, MXenes, titanate nanosheets, and combinations thereof.
